(19) United States
(12) Patent Application Publication
(10) Pub. No.: US 2009/0278865 A1
(43) Pub. Date: Nov. 12, 2009

(54) SOURCE DRIVER AND DISPLAY DEVICE INCLUDING THE SAME

(75) Inventors: Jae Sung Kang, Suwon-si (KR); Si Woo Kim, Hwaseong-si (KR); Hyo Jin Kim, Suwon-si (KR); Jong-Hyun Kim, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/420,924

(22) Filed: Apr. 9, 2009

(30) Foreign Application Priority Data
May 7, 2008 (KR) 2008-42143

(51) Int. Cl. G09G 5/10

(52) U.S. Cl. 345/690

(57) ABSTRACT

A source driver having a small layout area and low power consumption includes a signal generation block generating a plurality of pulse width modulation (PWM) signals and a plurality of staircase waveform grayscale voltage signals according to a digital code generated based on an oscillation signal and a channel driver. The channel driver divides latched video data into upper bits and lower bits, generates a plurality of switching signals using one PWM signal selected from among the plurality of PWM signals in response to the lower bits, outputs one staircase waveform grayscale voltage signal selected from among the plurality of staircase waveform grayscale voltage signals in response to the upper bits, and outputs a particular grayscale voltage level included in the one staircase waveform grayscale voltage signal in response to the plurality of switching signals.

### CROSS-REFERENCE TO RELATED APPLICATIONS

This application claims priority under 35 U.S.C. §119 to Korean Patent Application No. 10-2008-0042143, filed on May 7, 2008, in the Korean Intellectual Property Office, the disclosure of which is incorporated herein by reference.

### BACKGROUND

1. Field of the Invention

Example of the present general inventive concept relates to a semiconductor device, and more particularly, to a source driver to eliminate channel voltage deviations with a small layout area and a display device including the same.

2. Description of the Related Art

FIG. 1 is a block diagram of a conventional source driver 5 of a display device 1. Referring to FIG. 1, a system using 256 KB (=2¹⁸ byte)-color mode receives 6-bit digital video data of each of red, green, and blue (RGB) and displays an image using an 18-bit source driver 5. The source driver 5 includes a plurality of channel drivers, each of which requires as many level shifters as the number of bits of digital video data in order to shift the digital video data from a low voltage level (e.g., 1.5 V or lower) at which the digital video data is driven to a liquid crystal display (LCD) source driving voltage level (e.g., 4.5 V or higher). For instance, when a single channel driver (e.g., a channel driver driving blue video data B_DATA) drives 6-bit video data, the channel driver requires 6 level shifters.

In addition, to convert 6-bit video data into an analog signal, the source driver requires a 6-bit digital-to-analog converter (DAC). In FIG. 1, a 64-to-1 multiplexer (MUX) corresponds to the 6-bit DAC and signals corresponding to 64 lines of corresponding voltages between gamma GVDD and VGS based on Gamma register setting. The source driver 5 illustrated in FIG. 1 uses the 64-to-1 MUX occupying a large layout area in order to convert digital video data into an analog signal. Moreover, in the source driver illustrated in FIG. 1, a unit gain buffer (AMP) to buffer an output signal of the 64-to-1 MUX drives its own output load. Accordingly, an offset may occur among gain buffers implemented in the respective channel drivers. As a result, channel voltage deviations among channels may occur.

Meanwhile, the source driver requires 720 (=240*3) channel drivers for a quarter video graphic array (QVGA). A large area is required as a layout area of the 720 channel drivers, for example, 1,820,160 μm² (=16 μm*720*158 μm). The required large area causes various problems, for example, manufacturing costs and complicated processes. Moreover, power consumption of level shifters three times more than the number of channels and 64-to-1 MUXs as many as the number of channels is significant.

### SUMMARY

Some embodiments of the present general inventive concept provide a source driver to reduce power consumption and the layout area of a channel driver and to eliminate channel voltage deviations and a display device including the source driver.

Additional aspects and utilities of the present general inventive concept will be set forth in part in the description which follows and, in part, will be obvious from the description, or may be learned by practice of the general inventive concept.

According to some embodiments and utilities of the present general inventive concept, there is provided a source driver including a data latch configured to divide latched video data into upper bits and lower bits, a switching signal generation circuit configured to generate a plurality of switching signals using one pulse width modulation (PWM) signal selected from among a plurality of PWM signals in response to the lower bits, a decoder configured to output one staircase waveform grayscale voltage signal selected from among a plurality of staircase waveform grayscale voltage signals in response to the upper bits, and an output circuit configured to output a particular grayscale voltage level included in the staircase waveform grayscale voltage signal output from the decoder in response to the plurality of switching signals.

The source driver further includes a PWM signal generation circuit configured to generate the plurality of PWM signals according to a digital code generated based on an oscillation signal, a grayscale voltage generator configured to generate a plurality of grayscale voltages, and a staircase waveform grayscale voltage signal generation circuit configured to generate the plurality of staircase waveform grayscale voltage signals according to the digital code. Each of the staircase waveform grayscale voltage signals may include some grayscale voltages decoded according to the digital code among the plurality of grayscale voltages.

The PWM signal generation circuit may include an oscillator configured to generate the oscillation signal, a frequency divider configured to divide a frequency of the oscillation signal by a predetermined division ratio and generate an oscillation signal having a divided frequency, a code generator configured to count the oscillation signal having the divided frequency and generate the digital code as a count result, and a PWM signal generator configured to generate the plurality of PWM signals in response to the digital code.

The staircase waveform grayscale voltage signal generation circuit may include a plurality of decoders, each of which generates some decoded grayscale voltages using corresponding some grayscale voltages among the plurality of grayscale voltages and the digital code.

According to other embodiments and utilities of the present general inventive concept, there is provided a display device including a pixel array including a data line connected with a pixel and a source driver configured to apply a driving voltage to the data line. The source driver includes a data latch configured to divide latched video data into upper bits and lower bits, a switching signal generation circuit configured to generate a plurality of switching signals using one PWM signal selected from among a plurality of PWM signals in response to the lower bits, a decoder configured to output one staircase waveform grayscale voltage signal selected from among a plurality of staircase waveform grayscale voltage signals in response to the upper bits, and an output circuit configured to output a particular grayscale voltage level included in the staircase waveform grayscale voltage signal output from the decoder in response to the plurality of switching signals to the data line as the driving voltage.

The source driver may further include a PWM signal generation circuit configured to generate the plurality of PWM signals according to a digital code generated based on an oscillation signal, a grayscale voltage generator configured to generate a plurality of grayscale voltages, and a staircase waveform grayscale voltage signal generation circuit configured to generate the plurality of staircase waveform grayscale voltage signals according to the digital code. Each of the staircase waveform grayscale voltage signals may include some grayscale voltages decoded according to the digital code among the plurality of grayscale voltages.

According to further embodiments and utilities of the present general inventive concept, there is provided a source driver including a signal generation block configured to generate a plurality of PWM signals and a plurality of staircase waveform grayscale voltage signals according to a digital code generated based on an oscillation signal and a plurality of channel drivers. Each of the channel drivers includes a data latch configured to divide latched video data into upper bits and lower bits, a switching signal generation circuit configured to generate a plurality of switching signals using one PWM signal selected from among the plurality of PWM signals in response to the lower bits, a decoder configured to output one staircase waveform grayscale voltage signal selected from among the plurality of staircase waveform grayscale voltage signals in response to the upper bits, and an output circuit configured to output a particular grayscale voltage level included in the staircase waveform grayscale voltage signal output from the decoder in response to the plurality of switching signals.

The signal generation block may include a PWM signal generation circuit configured to generate the plurality of PWM signals according to the digital code generated based on the oscillation signal, a grayscale voltage generator configured to generate a plurality of grayscale voltages, and a staircase waveform grayscale voltage signal generation circuit configured to generate the plurality of staircase waveform grayscale voltage signals according to the digital code. Each of the staircase waveform grayscale voltage signals may include some grayscale voltages decoded according to the digital code among the plurality of grayscale voltages.

According to further embodiments and utilities of the present general inventive concept, there is also provided a source driver usable with a display device, including a channel driver configured to generate a plurality of switching signals according a first portion of data and a track signal, to generate a video signal according to a group of grayscale voltage signals and a second portion of the data, and to output a source line signal to drive an external display panel according to the video signal and the switching signals.

The channel driver may include a selection circuit unit to receive the first portion of data and the track signal and to generate a plurality of switching signals, a decoder unit to receive the second portion of the data and the group of grayscale voltage signals and to generate a video signal, and an output circuit unit to receive the video signal and the switching signals and to output the source line signal.

The channel drive may be formed in one of a single semiconductor chip, a semiconductor chip package, and a signal printed circuit board.

The channel drive may include a plurality of channel drivers to correspond to a plurality of pixels of the display panel, and each of the channel drivers may have an area less than an area of 2,528 μm².

The channel drive may include a plurality of channel drivers to correspond to a plurality of pixels of the display panel, and each of the channel drivers may have an area of 1,050 μm².

According to further embodiments and utilities of the present general inventive concept, there is also provided a display device including a display panel, and a source driver connected to the display panel through a communication line, including a signal generation block to generate the group of grayscale voltage signals and the track signal, and a channel driver configured to generate a plurality of switching signals according a first portion of data and a track signal, to generate a video signal according to a group of grayscale voltage signals and a second portion of the data, and to output a source line signal to drive an external display panel signal according to the video signal and the switching signals.

The display device may further include a memory to store the data, and a controller to control the memory to store the data and to output the data to the source driver and to generate a signal to control the display panel to display an image according to the source line signal and a gate signal.

According to further embodiments and utilities of the present general inventive concept, there is also provided a method of a source driver usable with a display device, the method including generating a plurality of switching signals according a first portion of data and a track signal, generating a video signal according to a group of grayscale voltage signals and a second portion of the data, and outputting a source line signal to drive an external display panel according to the video signal and the switching signals.

According to further embodiments and utilities of the present general inventive concept, there is also provided a computer readable medium to contain computer readable codes as a program to perform a method of a source driver usable with a display device, the method including generating a plurality of switching signals according a first portion of data and a track signal, generating a video signal according to a group of grayscale voltage signals and a second portion of the data, and outputting a source line signal to drive an external display panel according to the video signal and the switching signals.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a schematic block diagram illustrating a conventional source driver;

FIG. 2 is a schematic block diagram illustrating a source driver usable with a display device according to some embodiments of the present general inventive concept;

FIG. 3 is a schematic block diagram illustrating a signal generation block of FIG. 2;

FIG. 4 is a schematic block diagram illustrating a 1-channel driver of FIG. 2;

FIG. 5 is a graph illustrating a 4-bit global gamma digital-to-analog converter (DAC) region according to some embodiments of the present general inventive concept;

FIG. 6 is a graph illustrating a process of tracking a pulse width modulation (PWM) signal according to some embodiments of the present general inventive concept;

FIG. 7 is a table in which 6-bit video data is divided into upper two bits and lower four bits according to some embodiments of the present general inventive concept;

FIG. 8 is a circuit diagram illustrating a 1-bit level shifter of FIG. 4;

FIG. 9 is a timing chart illustrating sample/hold switches according to some embodiments of the present general inventive concept;

FIG. 10 illustrates positive gamma curves according to some embodiments of the present general inventive concept;

FIG. 11 illustrates negative gamma curves according to some embodiments of the present general inventive concept;

FIG. 12 illustrates the layout area of the 1-channel driver of FIG. 2; and

FIG. 13 is a flowchart illustrating a method of a source driver usable with a display device according to some embodiments of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the general inventive concept. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

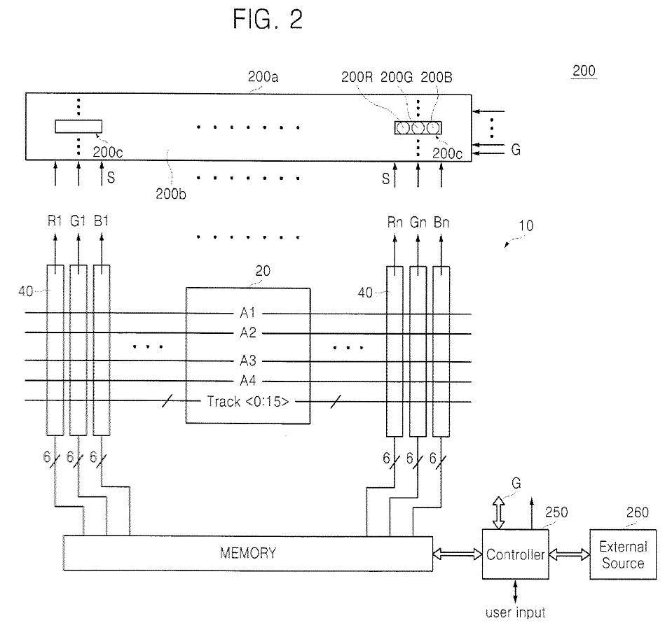

FIG. 2 is a block diagram of a source driver 10 usable with a display device 200 according to some embodiments of the present general inventive concept. The source driver (or data line driver) 10 may be used in mobile terminals such as mobile phones, personal digital assistants (PDAs), portable multimedia players (PMPs), terminals with a display device, computer apparatuses to generate a signal to drive a display panel or unit, and so on. The source driver 10 includes a signal generation block 20 and a plurality of channel drivers R1 through Rn, G1 through Gn, and B1 through Bn 40 where “n” is a natural number. For instance, when the source driver 10 drives a quarter video graphic array (QVGA), “n” is 240.

The signal generation block (or global block) 20 generates a plurality of pulse width modulation (PWM) signals Track<0:15> and a plurality of staircase waveform grayscale voltage signals A1, A2, A3 and A4 according to a digital code (4-bit) generated based on an oscillation signal. Each of the channel drivers R1 through Rn, G1 through Gn, and B1 through Bn drives each of a plurality of source lines (or data lines) provided in a display panel (not shown) in response to the PWM signals Track<0:15>, the staircase waveform grayscale voltage signals A1, A2, A3 and A4, and digital video data.

In other words, the display device 200 may include the source driver 10 and may further include a display panel 200a having a pixel array 200b including data lines S connected to corresponding pixels 200c. The pixel array includes a plurality of source lines (or data lines) S, a plurality of gate lines (or scan lines) G, and a plurality of pixels 200c connected between the source lines S and the gate lines G. The pixels 200c may have elements, for example, color elements 200R, 200G, and 200B corresponding to color components R, G, B to form a portion of an image displayed on a screen of the display panel 200a. The channel drivers R1 through Rn, G1 through Gn, and B1 through Bn drive the corresponding source lines S, respectively, so that the pixel array 200b can display video data.

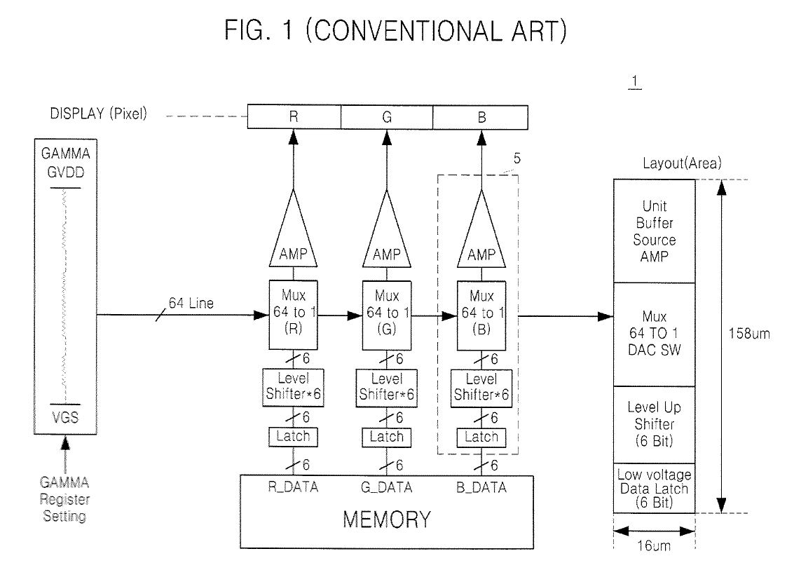

The source driver illustrated in FIG. 1 requires 64 metal lines to apply a plurality of grayscale voltages to each channel driver. The source driver 10 according to some embodiments of the present invention, however, requires only 4 metal lines for transmitting the staircase waveform grayscale voltage signals A1, A2, A3 and A4. Accordingly, a layout area for routing metal lines is decreased.

The source driver 10 may be used as a driving device for driving a flat display panel such as a thin-flat transistor liquid crystal display (TFT-LCD) panel, a plasma display panel (PDP), or an organic light emitting diode (OLED) panel. For instance, when the source driver 10 drives a QVGA, a total number of channels is 720, and therefore, the signal generation block 20 needs to simultaneously drive 720 channels.

The display device 200 may further include a controller 250 to generate first control signals to a memory to store data and to output the stored data to the respective source driver 10, to generate second control signals corresponding to the gate signals to the display panel 200a, and to generate third control signals to control the signal generation block 20 and/or other units to perform an operation of the display device 200. The controller 250 may receive data from a user through a user interface and an external source through a wired or wireless communication line. Data can be transmitted to the memory though the controller 250 and stored in the memory to generate video data to the source driver 10 to form an image on a screen of the display panel 200a. It is possible that on-screen display (OSD) data can be stored in the memory as the video data such that an OSD image can be displayed as the image of the screen of the display panel 200a. It is also possible that the video data and the OSD data can be stored in the memory to generate the video data to the source driver 10. Therefore, it is possible that the image displayed on the screen of the display panel 200a may be a combination of the OSD image corresponding to the OSD data and a video image corresponding to the video data. Since the user interface and the communication line are conventional and well known, detailed descriptions thereof will be omitted.

According to embodiments and utilities of the present general inventive concept, the source driver 10 may be formed with at least one of the signal generation block 20, the memory, the display panel 200a, the controller 250, and the external source 260 in a single body within a single housing. However, the present general inventive concept is not limited thereto. The source drive 10 is formed with the display panel 200a in a single body within a single housing, and the memory and the controller 250 may be formed in another single body within another single housing to be connected to a combination of the source drive 10 and the display panel 200a.

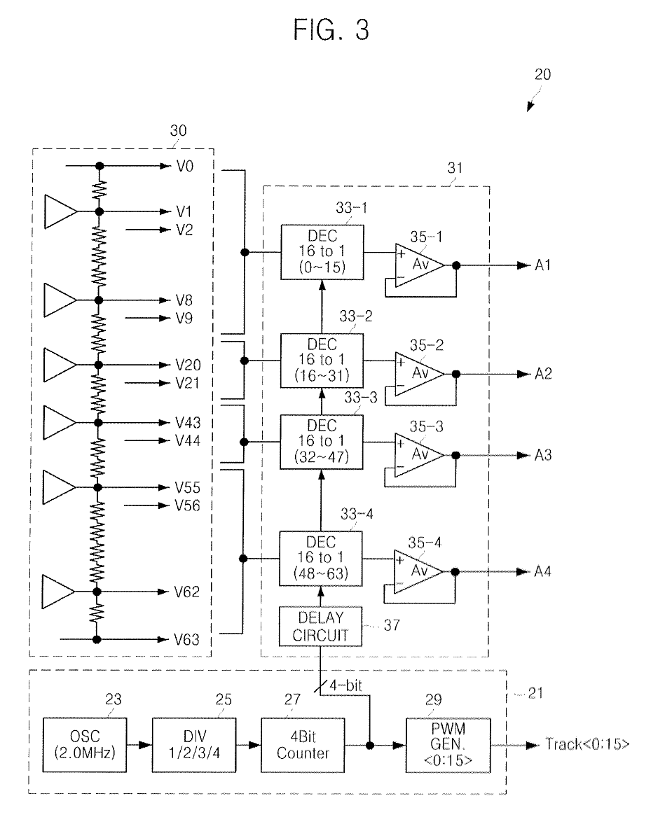

FIG. 3 is a block diagram of the signal generation block 20 illustrated in FIG. 2. The signal generation block 20 includes a PWM signal generation circuit 21, a grayscale voltage generator 30, and a staircase waveform grayscale voltage signal generation circuit 31. The PWM signal generation circuit 21 generates a plurality of PWM signals Track<0:15> according to a digital code (4-bit) generated based on an oscillation signal. The grayscale voltage generator 30 generates a plurality of grayscale voltages V0 through V63.

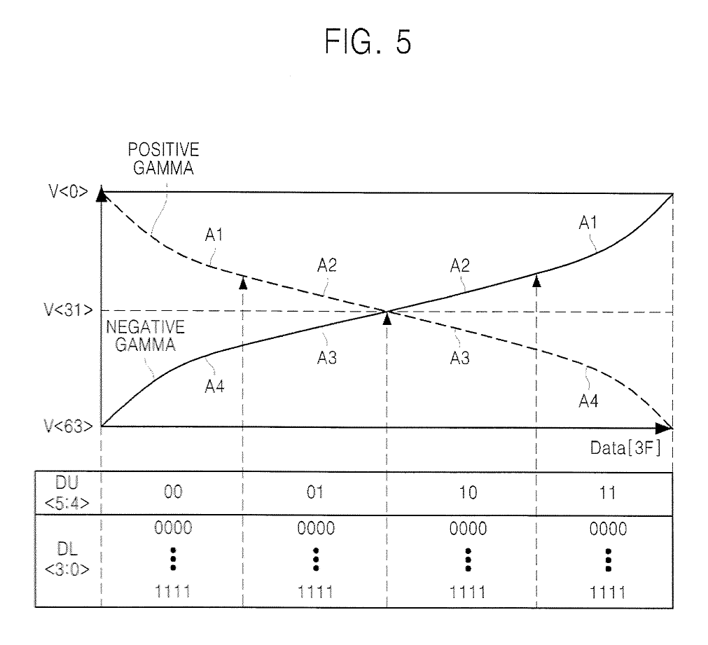

The staircase waveform grayscale voltage signal generation circuit 31 generates a plurality of staircase waveform grayscale voltage signals A1, A2, A3 and A4 according to a digital code (4-bit). The staircase waveform grayscale voltage signals A1, A2, A3 and A4 include groups, respectively, of a plurality of grayscale voltages V0 through V15, V16 through V31, V32 through V47, and V48 through V63, decoded according to the digital code (4-bit) output from the PWM signal generation circuit 21. For instance, as illustrated in FIG. 5, 10, or 11, the first staircase waveform grayscale voltage signal A1 includes a first group of grayscale voltages V0 through V15; the second staircase waveform grayscale voltage signal A2 includes a second group of grayscale voltages V16 through V31; the third staircase waveform grayscale voltage signal A3 includes a third group of grayscale voltages V32 through V47; and the fourth staircase waveform grayscale voltage signal A4 includes a fourth group of grayscale voltages V48 through V63.

The PWM signal generation circuit 21 includes an oscillator 23, a frequency divider 25, a code generator 27, and a PWM signal generator 29. The oscillator 23 may generate an oscillation signal having a frequency of 2.0 MHz or a frequency of 1.5 through 2.5 MHz. According to some embodiments of the present general inventive concept, the oscillator 23 may be implemented by a crystal oscillator.

The frequency divider 25 divides the frequency of an oscillation signal generated by the oscillator 23 by a predetermined division ratio and generates an oscillation signal having a divided frequency. The division ratio may be a real number. For instance, when the frequency of the oscillation signal generated by the oscillator 23 is 2 MHz, the frequency divider 25 having a division ratio of 1 generates an oscillation signal having a period of 0.5 μs; the frequency divider 25 having a division ratio of 2 generates an oscillation signal having a period of 1.0 μs; and the frequency divider 25 having a division ratio of 4 generates an oscillation signal having a period of 2.0 μs. As the division ratio increases, power consumption of the source driver 10 decreases. The frequency divider 25 may include a register (not illustrated) that sets the division ratio. Alternatively, the frequency divider 25 may generate an oscillation signal having a frequency resulting from frequency division performed at a division ratio set by an external register (not illustrated).

The code generator 27 may be implemented by a counter. The code generator 27 counts an oscillation signal having a divided frequency generated by the frequency divider 25 and generates a digital code (4-bit) as a count result. For instance, the code generator 27 may count the number of rising or falling edges of the oscillation signal and generate a K-bit digital code corresponding to a count result. Here, K is a natural number. Here, K may be 4 in the embodiments of the present general inventive concept for description purposes.

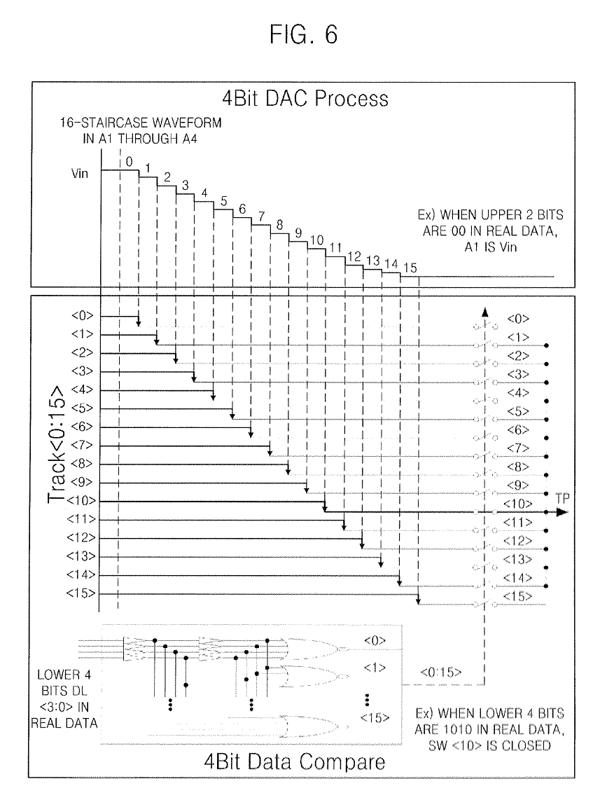

The PWM signal generator 29 generates the PWM signals Track<0:15> in response to the 4-bit digital code (4-bit) generated by the code generator 27. For instance, when the 4-bit digital code (4-bit) sequentially increases from “0000” to “1111”, the PWM signal generator 29 generates the PWM signals Track<0:15> whose pulse width increases by a period of 1 least significant bit (LSB), as illustrated in FIG. 6.

The grayscale voltage generator 30 generates a plurality of grayscale voltages. For clarity of the description, a resistor string to generate 64 grayscale voltages V0 through V63 is illustrated in the embodiments of the present general inventive concept. The grayscale voltage generator 30 generates the grayscale voltages V0 through V63 using a plurality of resistors connected between a first line receiving a first voltage Vfand a second line receiving a second voltage Vs.

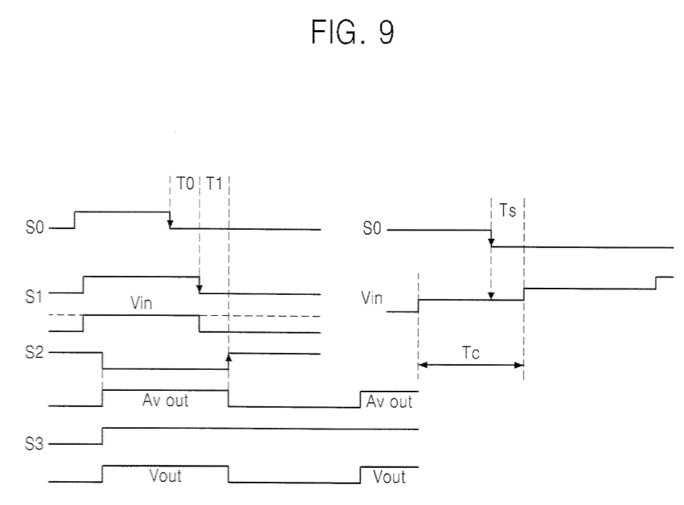

The staircase waveform grayscale voltage signal generation circuit 31 includes a plurality of decoders DEC 33-1, 33-2, 33-3, and 33-4 and a plurality of buffers 35-1, 35-2, 35-3, and 35-4. The staircase waveform grayscale voltage signal generation circuit 31 may further include a delay circuit 37 to control a delay Ts illustrated in FIG. 9. The delay circuit 37 may include a register (not illustrated) to store the delay Ts that can be externally set. Accordingly, the delay circuit 37 may delay a signal corresponding to each bit of the 4-bit digital code for the delay Ts.

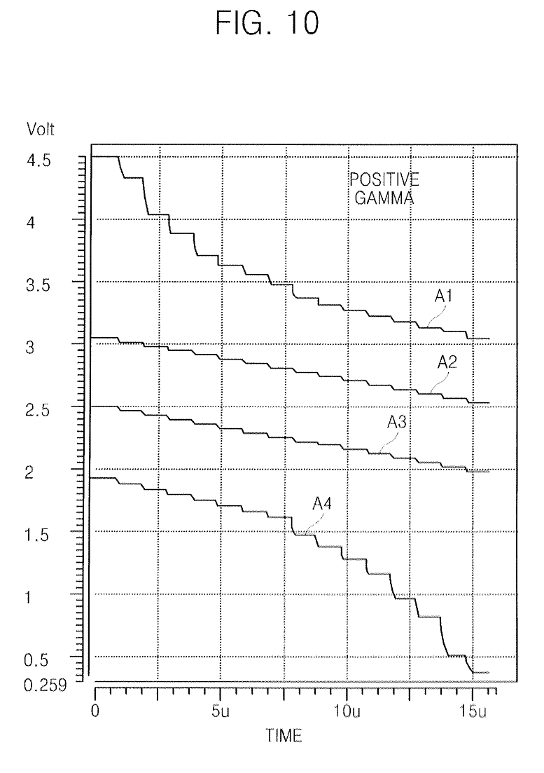

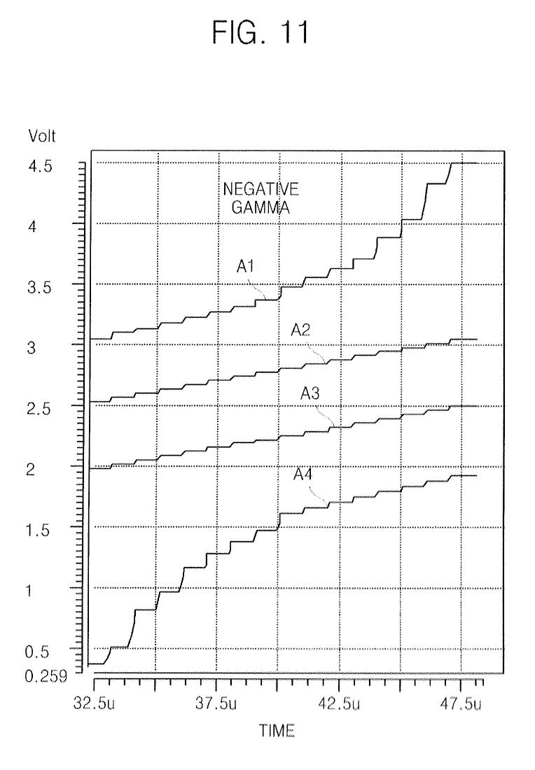

The first decoder DEC 33-1 receives the first group of grayscale voltages V0 through V15 among the 64 grayscale voltages V0 through V63 and outputs the first staircase waveform grayscale voltage signal A1 including the first group of grayscale voltages V0 through V15 decoded according to the 4-bit digital code from the PWM signal generation circuit 21 or the 4-bit digital code after being delayed by the delay circuit 37. For instance, when the 4-bit digital code sequentially increases from “0000” to “1111”, the first decoder DEC 33-1 outputs the first staircase waveform grayscale voltage signal A1 that sequentially decreases from the grayscale voltage V0 to the grayscale voltage V15 (e.g., a positive gamma illustrated FIG. 5 or 10) or sequentially increases from the grayscale voltage V0 to the grayscale voltage V15 (e.g., a negative gamma illustrated FIG. 5 or 11).

The second decoder DEC 33-2 receives the second group of grayscale voltages V16 through V31 among the 64 grayscale voltages V0 through V63 and outputs the second staircase waveform grayscale voltage signal A2 including the second group of grayscale voltages V16 through V31 decoded according to the 4-bit digital code from the PWM signal generation circuit 21 or the 4-bit digital code after being delayed by the delay circuit 37. For instance, when the 4-bit digital code sequentially increases from “0000” to “1111”, the second decoder DEC 33-2 outputs the second staircase waveform grayscale voltage signal A2 that sequentially decreases from the grayscale voltage V16 to the grayscale voltage V31 (e.g., a positive gamma illustrated FIG. 5 or 10) or sequentially increases from the grayscale voltage V15 to the grayscale voltage V31 (e.g., a negative gamma illustrated FIG. 5 or 11).

The third decoder DEC 33-3 receives the third group of grayscale voltages V32 through V47 among the 64 grayscale voltages V0 through V63 and outputs the third staircase waveform grayscale voltage signal A3 including the third group of grayscale voltages V32 through V47 decoded according to the 4-bit digital code from the PWM signal generation circuit 21 or the 4-bit digital code after being delayed by the delay circuit 37. For instance, when the 4-bit digital code sequentially increases from “0000” to “1111”, the third decoder 33-3 outputs the third staircase waveform grayscale voltage signal A3 that sequentially decreases from the grayscale voltage V32 to the grayscale voltage V47 (e.g., a positive gamma illustrated FIG. 5 or 10) or sequentially increases from the grayscale voltage V32 to the grayscale voltage V47 (e.g., a negative gamma illustrated FIG. 5 or 11).

The fourth decoder DEC 33-4 receives the fourth group of grayscale voltages V48 through V63 among the 64 grayscale voltages V0 through V63 and outputs the fourth staircase waveform grayscale voltage signal A4 including the fourth group of grayscale voltages V48 through V63 decoded according to the 4-bit digital code from the PWM signal generation circuit 21 or the 4-bit digital code after being delayed by the delay circuit 37. For instance, when the 4-bit digital code sequentially increases from “0000” to “1111”, the fourth decoder 33-4 outputs the fourth staircase waveform grayscale voltage signal A1 that sequentially decreases from the grayscale voltage V48 to the grayscale voltage V63 (e.g., a positive gamma illustrated FIG. 5 or 10) or sequentially increases from the grayscale voltage V48 to the grayscale voltage V63 (e.g., a negative gamma illustrated FIG. 5 or 11).

The buffers 35-1 through 35-4 respectively buffer the staircase waveform grayscale voltage signals A1 through A4 respectively output from the decoders 33-1 through 33-4. Each of the buffers 35-1 through 35-4 may be implemented by a unit gain buffer or an operational amplifier. The PWM signals Track<0:15> and the staircase waveform grayscale voltage signals A1 through A4 are provided to each of the channel drivers R1 through Rn, G1 through Gn, and B1 through Bn.

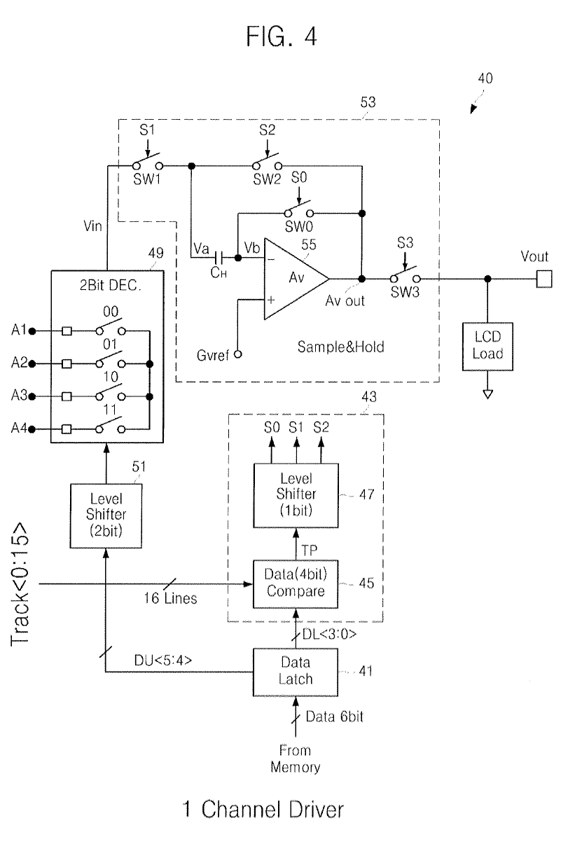

FIG. 4 is a block diagram illustrating one of the channel drivers 40 of the source driver 10 of FIG. 2. Referring to FIG. 4, the channel driver 40 includes a data latch 41, a switching signal generation circuit 43, a decoder 49, and an output circuit 53. The data latch 41 receives video data corresponding to one channel from the memory of FIG. 2 and latches the video data. The data latch 41 divides the latched video data into upper bits DU<5:4> and lower bits DL<3:0> and outputs the upper bits DU<5:4> to the decoder 49 or a level shifter 51 (if it is provided) and the lower bits DL<3:0> to the switching signal generation circuit 43. For instance, when the video data is 6 bits, the data latch 41 may divide the 6-bit video data into upper two bits DU<5:4> and lower four bits DL<3:0>.

The switching signal generation circuit 43 generates a plurality of switching signals S1, S2, and S3 using a PWM signal TP selected from the PWM signals Track<0:15> output from the PWM signal generator 29 in response to the lower four bits DL<3:0>. The switching signal generation circuit 43 includes a selection circuit 45 to select the PWM signal TP from the PWM signals Track<0:15> in response to the lower four bits DL<3:0>.

Referring to FIG. 6, when the lower four bits DL<3:0> are “1010”, the selection circuit 45 turns on a switch <10> to select a PWM signal Track <10> in response to “1010” and outputs a PWM signal Track<10>. For instance, when the PWM signals Track<0:15> are input to the selection circuit 45 after the lower four bits DL<3:0> are input thereto, the selection circuit 45 selectively outputs one of the PWM signals Track<0:15> in response to the lower four bits DL<3:0>. When the lower four bits DL<3:0> are “0000”, a PWM signal Track<0> is selected. When the lower four bits DL<3:0> are “0001”, a PWM signal Track<1> is selected. When the lower four bits DL<3:0> are “1111”, a PWM signal Track<15> is selected.

The switching signal generation circuit 43 increases the level of the PWM signal TP output from the selection circuit 45 and generates the switching signals S1 through S3 having an increased level. The level of the PWM signal output from the selection circuit 45 is a logic level (e.g., 1.5 V or lower). Since a higher level (e.g., 4 through 6 V) is required to control the operation of each switch implemented in the output circuit 53, the switching signal generation circuit 43 needs a level shifter 47 to shift up the level of the PWM signal TP output from the selection circuit 45 to a required level suitable to control the output circuit 53.

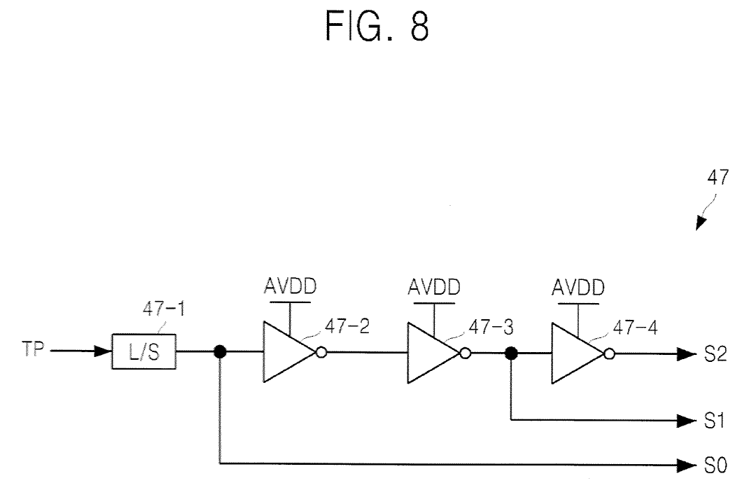

FIG. 8 is a circuit diagram of the level shifter 47 illustrated in FIG. 4. The level shifter 47 includes a latch/sampling circuit 47-1 and a plurality of inverters 47-2, 47-3, and 47-4 connected in series. An operating voltage AVDD of the inverters 47-2, 47-3, and 47-4 is higher than a logic level (e.g., 1.5 V). The latch/sampling circuit 51 latches and samples the input signal TP. The inverters 47-2, 47-3, and 47-4 generate first through third switching signals S0, S1, and S2 having the timing illustrated in FIG. 9.

Referring back to FIG. 4, the decoder 49 selectively outputs one of the staircase waveform grayscale voltage signals A1 through A4 in response to the upper two bits DU<5:4>. When the upper two bits DU<5:4> are “00”, “01”, “10”, or “11”, the decoder 49 outputs the first, second, third, or fourth staircase waveform grayscale voltage signal A1, A2, A3, or A4, respectively. For instance, when the upper two bits DU<5:4> are “00” as illustrated in FIG. 6, the decoder 49 outputs the first staircase waveform grayscale voltage signal A1 to the output circuit 53.

The channel driver 40 may further include a level-up shifter 51 connected between the data latch 41 and the decoder 49 to shift up the levels of the upper two bits DU<5:4>. The level-up shifter 51 shifts up the level of each of the upper two bits DU<5:4> in order to control the operation of switches included in the decoder 49. At this time, the decoder 49 outputs one of the staircase waveform grayscale voltage signals A1 through A4 in response to the upper two bits DU<5:4> whose levels have been shifted up by the level-up shifter 51.

The output circuit 53 includes a capacitor C_{H}, a plurality of switches SW0, SW1, SW2, and SW3, and an operational amplifier Av 55. The output circuit 53 performs a sample-hold operation on a particular grayscale voltage level among a plurality of grayscale voltage levels included in a staircase waveform grayscale voltage signal Vin output from the decoder 49 using the capacitor C_{H} and the switches, amplifies a voltage held at the capacitor C_{H} by the sample-hold operation using the operational amplifier 55, and outputs an amplified voltage Av out. Here, each of the switches may be implemented by a transmission gate or a metal-oxide-semiconductor field-effect transistor (MOSFET).

The output amplified voltage Av out may be transmitted as source line signals to data line S of the display panel 200a, such as an LCD load. According to an operation of the switch SW3. The switch SW3 may be disposed in the output circuit 53. However, it is possible that the switch SW3 may be disposed outside the output circuit 53 and disposed within the display panel 200a.

FIG. 9 is a timing chart illustrating sample/hold switches according to some embodiments of the present general inventive concept. The operation of the output circuit 53 will be described with reference to FIGS. 4, 8, and 9. A delay Ts of FIG. 9 may be controlled by the delay circuit 37 and “Tc” denotes a 1-LSB time of the code generator 27 or a single period of a staircase waveform grayscale voltage signal. When “Tc” increases, a stable grayscale voltage level can be obtained.

A delay T0 may be controlled by a characteristic of the inverters 47-2 and 47-3. A delay T1 may be controlled by a characteristic of the inverter 47-4. The amplified voltage Av out can be output from the amplifier Av 55 according to an operation of at least one of the switches SW0, SW1, SW2, and then the output amplified voltage Av out can be output as an output Vout to the load according to an operation of the switch SW3. A signal can be output as the switching signal of the switch SW3 from the controller 250 of FIG. 2. Although FIG. 9 illustrates the switching signal of the switch SW3 as a continuous on-state line, it is possible that the switching signal of the switch SW3 may be intermittently generated to selectively transmit the output amplified voltage Av out as the output Vout to the load.

When the first switching signal S0 for controlling on/off of a first switch SW0 transits from a second level (e.g., a low level) to a first level (e.g., a high level), the first switch is turned on. Accordingly, a voltage Vb of a second input terminal (e.g., a negative (−) input terminal) of the operational amplifier 55 becomes a reference voltage Gvref of a feedback signal voltage and the voltage Vb on the right plate of the capacitor C_{H} becomes half of a supply voltage (GVDD) of the operational amplifier 55. Thereafter, when the second switching signal S1 for controlling on/off of a second switch SW1 transits from the second level to the first level, the second switch SW1 is turned on. While the second switching signal S1 remains at the first level, the particular grayscale voltage level, i.e., a grayscale voltage level to be sampled among the plurality of grayscale voltage levels included in the staircase waveform grayscale voltage signal Vin is charged at the left plate of the capacitor C_{H}. Accordingly, the capacitor C_{H} is charged with charges corresponding to a difference ΔVi between the grayscale voltage level (Vin) to be sampled and the voltage Vb of the right plate of the capacitor C_{H} (i.e., ΔVi=Vin−Vb).

When the third switching signal S2 transits from the second level to the first level after the first and second switching signals S0 and S1 transit from the first level to the second level, an output voltage of the operational amplifier 55 is 0, and therefore, the voltage Vb of the second input terminal of the operational amplifier 55 is −ΔVi. At this time, the operational amplifier 55 operates in a differential mode, thereby amplifying a voltage held at the capacitor C_{H}.

While the switching signal generation circuit 43 is selecting a PWM signal, a fourth switch SW3 turned on or off in response to a fourth switching signal S3 interrupts transmission of a voltage amplified by the operational amplifier 55 to an LCD load, i.e., a source line of a display panel. Accordingly, the fourth switch functions to reduce power consumption of a display device.

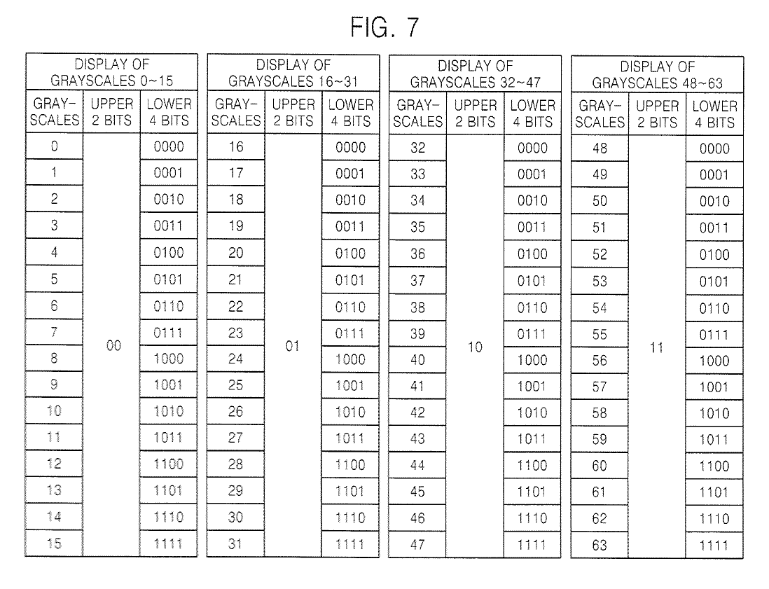

FIG. 7 is a table in which 6-bit video data is divided into upper two bits and lower four bits according to some embodiments of the present invention. Each of the grayscale voltages V0 through V63 is determined by a combination of the upper two bits DU<5:4> and the lower four bits DL<3:0>. FIG. 10 illustrates positive gamma curves according to some embodiments of the present invention. FIG. 11 illustrates negative gamma curves according to some embodiments of the present invention. Referring to FIGS. 5, 10, and 11, each of the staircase waveform grayscale voltage signals A1 through A4 includes a 16-staircase waveform, i.e., 16 grayscale voltages sequentially decreasing (e.g., positive gamma) or increasing (e.g., negative gamma).

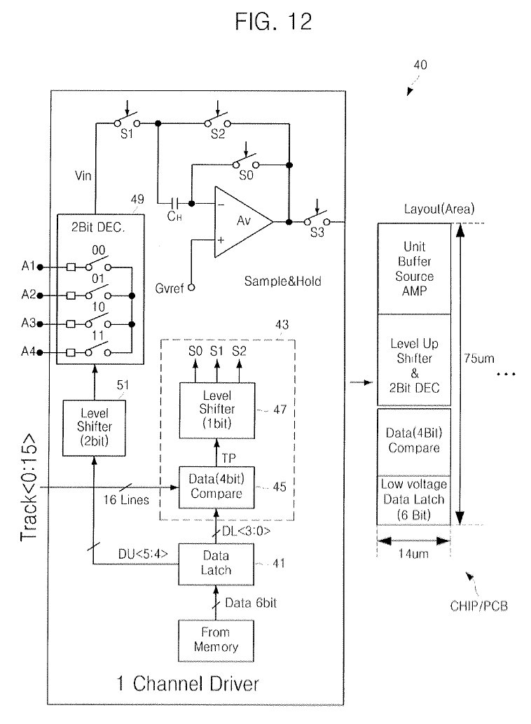

FIG. 12 illustrates a layout area of a single channel driver 40 illustrated in FIG. 2. Referring to FIGS. 1 and 12, the layout area of a single channel driver illustrated in FIG. 1 is 2,528 μm², i.e., 16 μm*158 μm, but the layout area of the single channel driver 40 of FIG. 2 or FIG. 12 is decreased to 1,050 μm², i.e., 14 μm*75 μm.

According to embodiments and utilities of the present general inventive concept, a total area of the channel drivers 40 of the source driver 10 can be formed in a single semiconductor chip. It is possible that a total area of the channel drivers 40 of the source driver 10 can be formed in a semiconductor chip package having a plurality of semiconductor chips electrically connected to each other and/or a printed circuit board (PCB) mounted with and connected to the plurality of semiconductor chips. It is also possible that a total area of the channel drivers 40 of the source driver 10 can be formed in a single printed circuit having at least one semiconductor chip.

According to embodiments and utilities of the present general inventive concept, a combination of elements of the source driver 10, elements of the display panel 200a, the memory, and the controller 250 can be formed in a single semiconductor chip, a semiconductor chip package, or a printed circuit board (PCB).

Since the layout area of the channel driver 40 is reduced, an area of the source driver 10 is also reduced to minimize an area occupied with the corresponding elements of the source driver 10, thereby to reduce a size of an apparatus or device to generate an image signal to drive a display array, or to reduce an area within the apparatus or device to accommodate the elements of the source driver 10. Therefore, the apparatus or device may be portable and mobile apparatus or device with a reduced size.

Even if the apparatus or device is the same as a conventional apparatus or device, the apparatus or device can have more available space therewithin to accommodate additional elements to perform additional functions since the elements of the source driver 10 is reduced to provide the above described available space.

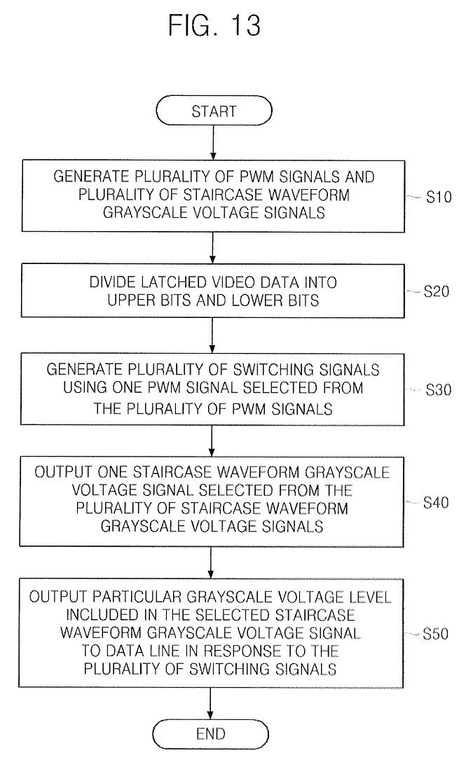

FIG. 13 is a flowchart illustrating a method of the source driver 10 according to some embodiments of the present general inventive concept. Referring to FIGS. 2 through 13, the signal generation block 20 of the source driver 10 generates a plurality of PWM signals Track<0:15> and a plurality of staircase waveform grayscale voltage signals A1 through A4 according to a digital code generated based on an oscillation signal in operation S10.

Each of the channel drivers 40 of the source driver 10 divides latched video data into upper bits DU<5:4> and lower bits DL<3:0> in operation S20. The switching signal generation circuit 43 of the source driver 10 generates a plurality of switching signals S0, S1, and S2 using one PWM signal TP selected from the PWM signals Track<0:15> in response to the lower bits DL<3:0> in operation S30.

The decoder 49 of the source driver 10 selectively outputs one staircase waveform grayscale voltage signal Vin among the staircase waveform grayscale voltage signals A1 through A4 in response to the upper bits DU<5:4> in operation S40. The output circuit 53 of the source driver 10 amplifies a particular grayscale voltage level among a plurality of grayscale voltages included in the staircase waveform grayscale voltage signal Vin output from the decoder 49 through a sample-hold operation performed in response to the switching signals S0, S1, and S2 and outputs an amplified signal to a data line in operation S50.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

According to some embodiments of the present general inventive concept, the layout area of a channel driver included in a source driver can be greatly reduced, so that the layout area of the source driver can also be greatly reduced. In addition, power consumption of the source driver can be remarkably reduced and a channel voltage deviation can be significantly decreased.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A source driver usable with a display device, comprising:
a data latch configured to divide latched video data into upper bits and lower bits;
a switching signal generation circuit configured to generate a plurality of switching signals using one pulse width modulation (PWM) signal selected from among a plurality of PWM signals in response to the lower bits;
a decoder configured to output one staircase waveform grayscale voltage signal selected from among a plurality of staircase waveform grayscale voltage signals in response to the upper bits; and
an output circuit configured to output a particular grayscale voltage level comprised in the staircase waveform grayscale voltage signal output from the decoder in response to the plurality of switching signals.

2. The source driver of claim 1, wherein the switching signal generation circuit comprises:
a selection circuit configured to output the PWM signal selected from among the plurality of PWM signals in response to the lower bits; and
a level shifter configured to shift a level of the PWM signal output from the selection circuit and generate the plurality of level-shifted switching signals.

3. The source driver of claim 1, further comprising:
a level shifter connected between the data latch and the decoder to shift a level of each of the upper bits, wherein the decoder outputs one of the plurality of staircase waveform grayscale voltage signals in response to level-shifted upper bits.

4. The source driver of claim 1, wherein the output circuit comprises:
a capacitor and a plurality of switches configured to perform a sample-hold operation on the particular grayscale voltage level in response to the plurality of switching signals; and
an operational amplifier configured to amplify a voltage held at the capacitor by the sample-hold operation.

5. The source driver of claim 1, further comprising:
a PWM signal generation circuit configured to generate the plurality of PWM signals according to a digital code generated based on an oscillation signal;
a grayscale voltage generator configured to generate a plurality of grayscale voltages; and
a staircase waveform grayscale voltage signal generation circuit configured to generate the plurality of staircase waveform grayscale voltage signals according to the digital code,
wherein each of the staircase waveform grayscale voltage signals comprises some grayscale voltages decoded according to the digital code among the plurality of grayscale voltages.

6. The source driver of claim 5, wherein the PWM signal generation circuit comprises:
an oscillator configured to generate the oscillation signal;
a frequency divider configured to divide a frequency of the oscillation signal by a predetermined division ratio and generate an oscillation signal having a divided frequency;
a code generator configured to count the oscillation signal having the divided frequency and generate the digital code as a count result; and
a PWM signal generator configured to generate the plurality of PWM signals in response to the digital code.

7. The source driver of claim 5, wherein the staircase waveform grayscale voltage signal generation circuit comprises a plurality of decoders, each of which generates some decoded grayscale voltages using corresponding some grayscale voltages among the plurality of grayscale voltages and the digital code.

8. The source driver of claim 5, wherein the staircase waveform grayscale voltage signal generation circuit comprises:
a delay circuit configured to delay the digital code; and
a plurality of decoders, each of which generates some decoded grayscale voltages using corresponding some grayscale voltages among the plurality of grayscale voltages and a digital code output from the delay circuit.

9. A display device comprising:
a pixel array comprising a data line connected with a pixel; and
a source driver configured to apply a driving voltage to the data line,
wherein the source driver comprises:
a data latch configured to divide latched video data into upper bits and lower bits;
a switching signal generation circuit configured to generate a plurality of switching signals using one pulse width modulation (PWM) signal selected from among a plurality of PWM signals in response to the lower bits;
a decoder configured to output one staircase waveform grayscale voltage signal selected from among a plurality of staircase waveform grayscale voltage signals in response to the upper bits; and
an output circuit configured to output a particular grayscale voltage level comprised in the staircase waveform grayscale voltage signal output from the decoder in response to the plurality of switching signals to the data line as the driving voltage.

10. The display device of claim 9, wherein the switching signal generation circuit comprises:
a selection circuit configured to output the PWM signal selected from among the plurality of PWM signals in response to the lower bits; and
a level shifter configured to shift a level of the PWM signal output from the selection circuit and generate the plurality of level-shifted switching signals.

11. The display device of claim 9, wherein the source driver further comprises a level shifter connected between the data latch and the decoder to shift a level of each of the upper bits, wherein the decoder outputs one of the plurality of staircase waveform grayscale voltage signals in response to level-shifted upper bits.

12. The display device of claim 9, wherein the output circuit comprises:
a capacitor and a plurality of switches configured to perform a sample-hold operation on the particular grayscale voltage level in response to the plurality of switching signals; and
an operational amplifier configured to amplify a voltage held at the capacitor by the sample-hold operation.

13. The display device of claim 9, wherein the source driver further comprises:
a PWM signal generation circuit configured to generate the plurality of PWM signals according to a digital code generated based on an oscillation signal;
a grayscale voltage generator configured to generate a plurality of grayscale voltages; and
a staircase waveform grayscale voltage signal generation circuit configured to generate the plurality of staircase waveform grayscale voltage signals according to the digital code, and
wherein each of the staircase waveform grayscale voltage signals comprises some grayscale voltages decoded according to the digital code among the plurality of grayscale voltages.

14. The display device of claim 13, wherein the PWM signal generation circuit comprises:
an oscillator configured to generate the oscillation signal;
a frequency divider configured to divide a frequency of the oscillation signal by a predetermined division ratio and generate an oscillation signal having a divided frequency;
a counter configured to count the oscillation signal having the divided frequency and generate the digital code as a count result; and
a PWM signal generator configured to generate the plurality of PWM signals in response to the digital code.

15. The display device of claim 13, wherein the staircase waveform grayscale voltage signal generation circuit comprises a plurality of decoders, each of which generates some decoded grayscale voltages using corresponding some grayscale voltages among the plurality of grayscale voltages and the digital code.

16. The display device of claim 13, wherein the staircase waveform grayscale voltage signal generation circuit comprises:
a delay circuit configured to delay the digital code; and
a plurality of decoders, each of which generates some decoded grayscale voltages using corresponding some grayscale voltages among the plurality of grayscale voltages and a digital code output from the delay circuit.

17. A source driver usable with a display device, comprising:
a signal generation block configured to generate a plurality of pulse width modulation (PWM) signals and a plurality of staircase waveform grayscale voltage signals according to a digital code generated based on an oscillation signal; and
a plurality of channel drivers,
wherein each of the channel drivers comprises:
a data latch configured to divide latched video data into upper bits and lower bits;
a switching signal generation circuit configured to generate a plurality of switching signals using one PWM signal selected from among the plurality of PWM signals in response to the lower bits;
a decoder configured to output one staircase waveform grayscale voltage signal selected from among the plurality of staircase waveform grayscale voltage signals in response to the upper bits; and
an output circuit configured to output a particular grayscale voltage level comprised in the staircase waveform grayscale voltage signal output from the decoder in response to the plurality of switching signals.

18. The source driver of claim 17, wherein the signal generation block comprises:
a PWM signal generation circuit configured to generate the plurality of PWM signals according to the digital code generated based on the oscillation signal;
a grayscale voltage generator configured to generate a plurality of grayscale voltages; and
a staircase waveform grayscale voltage signal generation circuit configured to generate the plurality of staircase waveform grayscale voltage signals according to the digital code, and
wherein each of the staircase waveform grayscale voltage signals comprises some grayscale voltages decoded according to the digital code among the plurality of grayscale voltages.

19. The source driver of claim 18, wherein the PWM signal generation circuit comprises:
an oscillator configured to generate the oscillation signal;
a frequency divider configured to divide a frequency of the oscillation signal by a predetermined division ratio and generate an oscillation signal having a divided frequency;
a counter configured to count the oscillation signal having the divided frequency and generate the digital code as a count result; and
a PWM signal generator configured to generate the plurality of PWM signals in response to the digital code.

20. A source driver usable with a display device, comprising:
a channel driver configured to generate a plurality of switching signals according a first portion of data and a track signal, to generate a video signal according to a group of grayscale voltage signals and a second portion of the data, and to output a source line signal to drive an external display panel according to the video signal and the switching signals.

21. The source driver of claim 20, wherein the channel driver comprises:
a selection circuit unit to receive the first portion of data and the track signal and to generate the plurality of switching signals;
a decoder unit to receive the second portion of the data and the group of grayscale voltage signals and to generate the video signal; and
an output circuit unit to receive the video signal and the switching signals and to output the source line signal.

22. The source driver of claim 20, wherein the channel driver is formed in one of a single semiconductor chip, a semiconductor chip package, and a signal printed circuit board.

23. The source driver of claim 20, wherein the channel driver comprises a plurality of channel drivers to correspond to a plurality of pixels of the display panel, and each of the channel drivers has an area less than an area of 1,050 μm².

24. A display device comprising:
a display panel; and
a source driver connected to the display panel through a communication line, comprising:
a signal generation block to generate the group of grayscale voltage signals and a track signal, and
a channel driver configured to generate a plurality of switching signals according a first portion of data and a track signal, to generate a video signal according to a group of grayscale voltage signals and a second portion of the data, and to output a source line signal to drive an external display panel signal according to the video signal and the switching signals.

25. The display device of claim 25, further comprising:
a memory to store the data; and
a controller to control the memory to store the data and to output the data to the source driver and to generate a signal to control the display panel to display an image according to the source line signal and a gate signal.

26. A method of a source driver usable with a display device, comprising:
generating a plurality of switching signals according a first portion of data and a track signal;
generating a video signal according to a group of grayscale voltage signals and a second portion of the data; and
outputting a source line signal to drive an external display panel according to the video signal and the switching signals.

27. A computer readable medium to contain computer readable codes as a program to perform a method of a source driver usable with a display device, the method comprising:
generating a plurality of switching signals according a first portion of data and a track signal;
generating a video signal according to a group of grayscale voltage signals and a second portion of the data; and
outputting a source line signal to drive an external display panel according to the video signal and the switching signals.
